(19) United States
(12) Patent Application Publication
(10) Pub. No.: US 2015/0243066 A1
(43) Pub. Date: Aug. 27, 2015

(54) SYSTEM FOR VISUALIZING ACOUSTIC INFORMATION

(71) Applicant: MICKAUS KURYBOS STUDIJA, MB, Vilnius (LT)

(72) Inventors: Virginijus Mickus, Vilnius (LT); Ruta Mickiene, Vilnius (LT)

(73) Assignee: MICKAUS KURYBOS STUDIJA, MB, Vilnius (LT)

(21) Appl. No.: 14/431,489

(22) PCT Filed: Dec. 17, 2012
(86) PCT No.: PCT/IB2012/057376

§ 371 Date: Mar. 26, 2015

(30) Foreign Application Priority Data
Oct. 23, 2012 (LT) 2012-100

(51) Int. Cl. G06T 13/80; G06F 3/16; G06T 11/00; H04R 29/00

(52) U.S. Cl. CPC G06T 13/80; H04R 29/008; G06F 3/162; G06T 11/001

(57) ABSTRACT

This invention provides a solution for artistic expression of acoustic information by employing an acoustic visualization system, comprising a sound receiving device, such as microphone, a display and, optionally, an information storage device, e.g. network based server. Said sound receiving and information storage devices are connected preferably through mobile/internet networks. Said sound receiving device and the display are preferably integrated into a user terminal having information processing capability, e.g. smart phone, tablet computer or similar device. The user terminal has a software product installed. Said software application features several conditional options for selecting from several types of containers, colors of illumination and several types of medium, used in the virtual acoustic visualization system. A distinct vibrational pattern is simulated according to analyzed acoustic information and conditional options. Another method for creating vibrational pattern comprises the steps of analyzing received acoustic information, picking out the most appropriate visual data from an information storage device, which stores a database of vibrational patterns, sending the image to the information processing device and optionally applying desired visual effects. Received acoustic information is preferably a verbal phrase and phonetic elements are words or syllables.

### FIELD OF INVENTION

This invention relates to methods of imaging. More particularly it relates to artistic imaging of acoustic waves by means of receiving the vibrational pattern from the database or simulating it.

### BACKGROUND OF INVENTION

There is a variety of methods used to visualize acoustic waves. These methods range from simple audio analyzers, to complex methods, which involve plurality of effects, for example acoustic holography.

Most of the acoustic imaging devices are functioning by means of receiving the sound signals, interpreting and processing them using information processing devices, such as personal computers, smart phones and similar. Processed data is displayed in the screen, connected to the information processing device, or printed. Previous patented inventions are known, describing methods of acoustic imaging.

A British patent No. GB1443443, published on 1973 Apr. 2, describes an acoustic imaging method, based on acoustic holography. Vibration sensors in an array are selectively energized by acoustic waves to form a vibratory pattern characteristic of the structure of an object being imaged, and the pattern is illuminated with coherent light in a holographic or interferometric imaging system to form a corresponding pattern of “live” or “time-averaged” interference fringes characteristic of the structure of the object. The array comprises a metal or ceramic plate diced on both sides to form acoustically-isolated half-wave resonators or quarter-wave resonators. The vibrational pattern set up on the array is made visible as “live fringes” by directing light from laser directly, and via reflection from the array's lower surface, on to a previously-recorded hologram of the array when stationary. The fringes are viewed through the hologram.

Another British patent No. GB1460056, published in 1976-12-31, discloses a method for detecting acoustic images, involving image, formed on polymer, scanning with the electron beam. An acoustic image produced by, e.g. foetus is focused by acoustic lens, through acoustic medium on to an imaging device, which comprises a thin foil of polymer having remanent electrical polarization mounted on a pressure resistant polymer face plate of, e.g. polystyrene or polyurethane. The image so formed is scanned by an electron beam in electron tube 12, and the resulting image displayed by, e.g. video recorder, T.V. monitor.

A Lithuanian patent application No. LT 2012-097 provides a solution for an artistic visualization of acoustic waves, employing an acoustic imaging system, which comprises a sound receiving device, an information processing device, an amplifier, a vibrational device, a container with a liquid or friable medium and an imaging device. Sound receiving device either encodes the variable acoustic information to the digital and transfers it to the information processing device or translates it to the analog signal and transfers it through analog line. The information processing device is arranged to separate input acoustic information into phonetic elements which are later visualized.

Said sound receiving and information processing devices are adapted to communicate through mobile communication or internet networks or through a simple wire connection. Digital or analog signal is sent to the vibrational device which oscillates upon the actuation of the input signal and produces acoustic waves as an output. Acoustic waves induce the formation of the vibratory pattern on the surface of the liquid or friable medium. The vibrational pattern is then captured by the imaging device and shown live on the display, broadcasted or multi-layer pictures are created and printed or stored in USB, CD or other data storage unit, or transferred to the user by means of data communication networks. Variable acoustic information is preferably a verbal phrase and phonetic elements are words or syllables.

Prior art inventions describe solutions, which are complex and more applicable in science or domestic needs, but feature quite low level of visual attraction and are rather difficult to use, thus their use is time consuming and requires certain skills.

### SUMMARY

An object of the present invention is to provide visualization means for an artistic expression of variable acoustic information and at the same time to alleviate the complexity problem mentioned above. In other words, the invention aims at providing a system, which comprises a sound receiving device e.g. microphone, display, information processing unit and optionally an information storage device, e.g. network based server. The information processing unit and said sound receiving and information storage devices are connected preferably through mobile or internet networks. Said sound receiving device and display are preferably integrated into a user terminal having information processing capability, e.g. smart phone, tablet computer or similar. Simplicity and elimination of an imaging device are considered as advantages, provided by this invention.

Said sound receiving device can be any device that converts the acoustic information to an analog or digital signal. A digital signal is adapted to be processed in an information processing device, which preferably is a smart phone with a dedicated software application installed. Said application features several conditional options for selecting from several types of containers, colors of illumination and several types of medium, used in virtual acoustic visualization system. These options are used for setting conditions in order to simulate the vibrational pattern based on the received acoustic information.

Another method for creating vibrational pattern comprises steps of analyzing received acoustic information, picking out the most appropriate image from an information storage device, which stores a database of vibrational patterns, sending the image to the information processing device and optionally applying desired visual effects. Said information storage device is any device, that is capable of storing considerable amounts of digital information, preferably pictures of vibrational patterns. Preferably information storage device is a server, but can be any of personal computer, notebook, tablet computer and similar.

### DESCRIPTION OF DRAWINGS

In order to understand the invention better, and appreciate its practical applications, the following pictures are provided and referenced hereafter. Figures are given as examples only and in no way limit the scope of the invention.

FIG. 1. illustrates the most preferred embodiment of the present invention, where the acoustic information is processed in a smart phone (1); depending on the selected options (4, 5, 6) a vibrational pattern (7) is simulated and shown in the display.

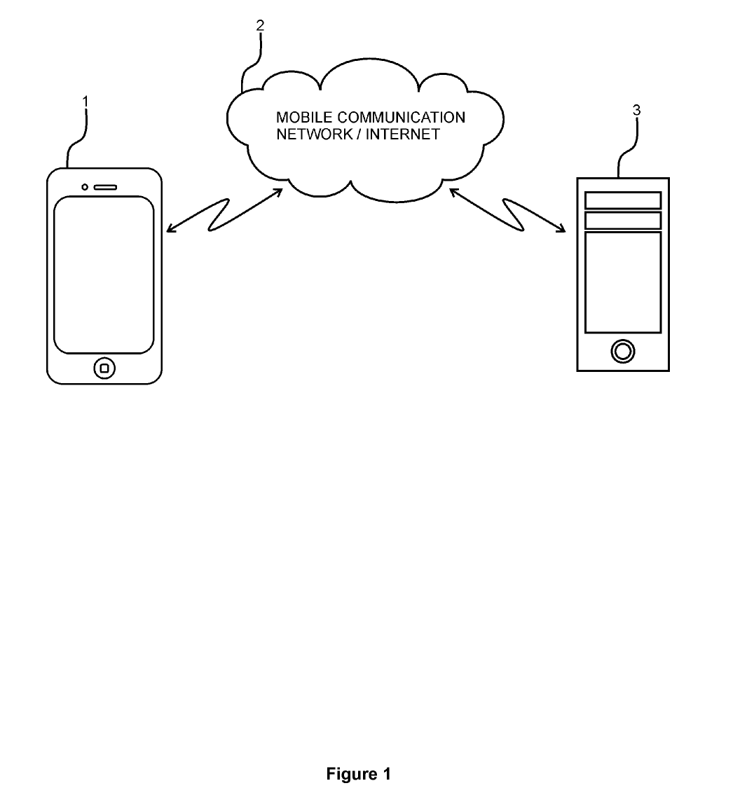

FIG. 2. illustrates an another embodiment of the present invention, where the acoustic information is processed in the smart phone (1) and a picture of the vibrational pattern is picked and downloaded from the information storage device (3).

FIG. 3. illustrates the block diagram of the visualization method, wherein visual data is simulated based on the received acoustic information.

FIG. 4. illustrates the block diagram of the visualization method, wherein visual data is picked from a database.

### DETAILED DESCRIPTION OF PREFERRED EMBODIMENTS

The most preferred embodiment of the present invention is an acoustic visualization system, comprising at least a sound receiving device and a display. Said sound receiving device and a display are preferably integrated into a complex information processing device, e.g. smart phone (1), tablet computer or similar.

In this context, said sound receiving device is any device that is capable of receiving acoustic waves and encoding them to digital or converting it to an analog electrical signal.

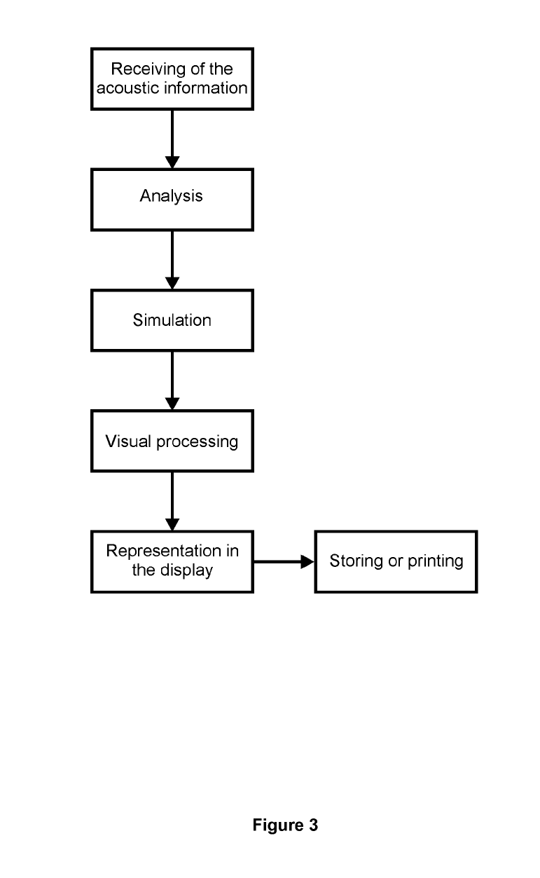

In the most preferred embodiment, acoustic signal, received by the sound receiving device, is encoded to a digital signal and processed in the information processing device, preferably a smart phone (1). In the most preferred embodiment, smart phone employs a software product, which is capable of simulating the vibrational pattern (7) according to the selected conditional options (4, 5, 6). The method, involving simulation, is shown in the FIG. 3.

Said vibrational pattern is achieved by employing a software product, in other words an application, which allows simulation of a system, comprising a container, filled with liquid or friable medium, a source of acoustic waves and a light source. In the most preferred embodiment, the source of acoustic waves is the acoustic information, received by the sound receiving device, which induces vibrations in the liquid or friable medium. Induced vibrations are illuminated with a light source and resulting vibrational pattern (7) is shown in a display.

In the most preferred embodiment of this invention, said application employs three different conditional options for simulating the vibrational pattern (7). The first option (4) allows the user to change the shape of the container, arranged to contain the liquid or friable medium. The second option (5) allows the user to change the type and properties of illumination. The third option (6) allows the user to change the type and properties of the liquid or friable medium. Depending on the selected options and the received acoustic information, different vibrational patterns are created. Created vibrational patterns can be shown in the display, saved in the information processing device, stored in CD, USB or any similar data storage unit or printed.

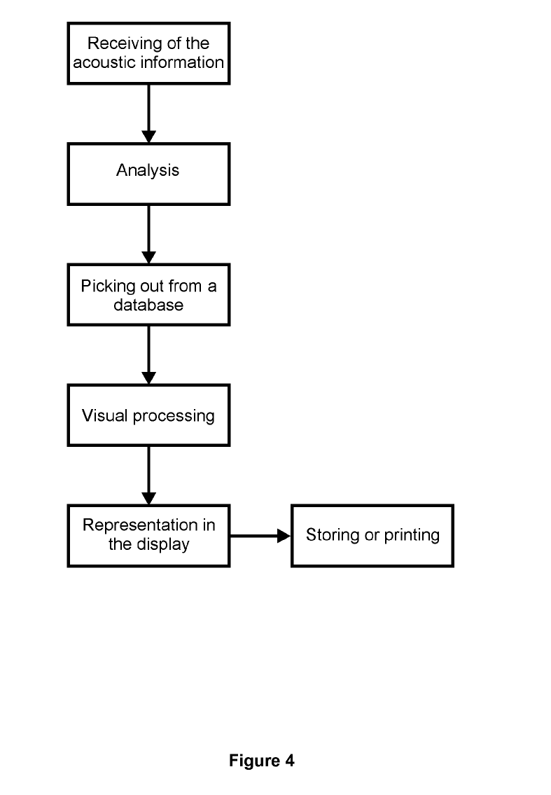

Yet in another preferred embodiment, acoustic visualization system also employs an information storage device (3). The information storage device (3) can be any device, that is capable of storing a database of visual data files. In this context, information storage device is used for storing pictures of vibrational patterns, induced in the liquid or friable medium, upon actuation of different acoustic signals and other conditions, such as illumination, shape of the container, etc. The method, involving picking of said visual data from the database, is shown in the FIG. 4.

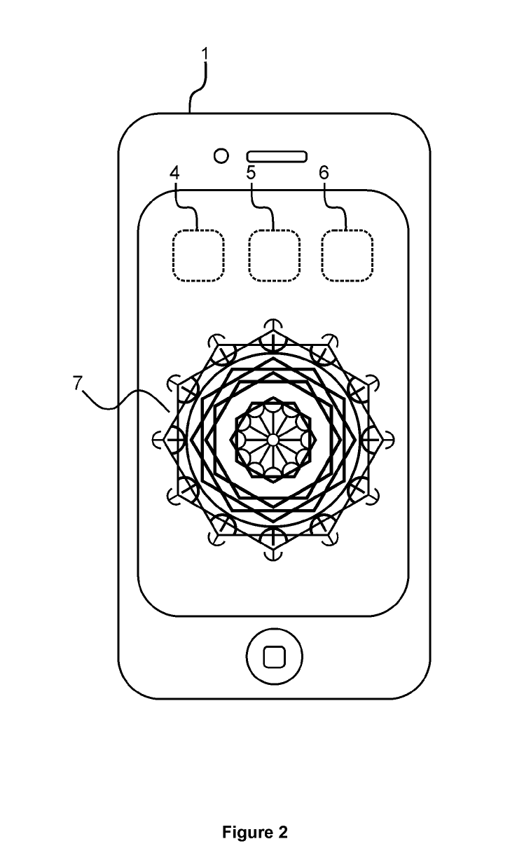

An acoustic signal, received by the sound receiving device, is analyzed either in the user terminal or sent to the information storage device (3) for further analysis. Key parameters, such as amplitude, frequency or similar are preferably the outcome of the analysis. Vibrational pattern (7), most appropriately representing the analyzed data, is picked out from the database of patterns and sent back to the information processing device and shown in a display, stored in CD, USB or any similar data storage unit or printed. As shown in FIG. 2, information processing device, preferably a smart phone (1) communicates with the information storage device (3) by means of data communication network (2). Such network enables multiple remote users of sending the audio signal to the information processing device. Data communication network comprises two types of telecommunications networks, the first one being the packet-switched network, which allows users to connect through an optical fiber, LAN, WiFi or similar standard method or protocol, whereas the second type is a mobile communication network, which supports standard protocols, such as GPRS, EDGE, GSM, WCDMA, 3G, 4G, HSDPA, etc. It should be appreciated that present invention is not limited to the specific type of data communication network and the person, skilled in the art, can apply such knowledge creatively for proper realization of this invention.

Yet in another preferred embodiment the information storage device stores fragments of vibrational patterns. Every fragment represents a parameter or a set of parameters of received and analyzed acoustic information. Fragments of vibrational patterns, most appropriately representing the analyzed data, are picked out from the database and sent to the information processing device. Vibrational pattern, comprising said fragments is formed in the information processing device. The shape of fragments is not limited as long as symmetrical image can be formed. The image is preferably built such that lines, between different fragments, are not clearly visible, by using state of the art graphical processing algorithms. Created image is shown in the display, stored in CD, USB or any similar data storage unit or printed.

In the most preferred embodiment, variable acoustic information, expressed by the user of the imaging system is a verbal phrase, pronounced by the user, musical work, performed with a musical instrument in real-time, acoustic information, produced by radio, TV, stereo system or any other device, which emits acoustic waves. Said acoustic information is separated into the number of phonetic elements or groups thereof. Each of the said phonetic elements or groups produce a distinct vibrational pattern in the liquid of friable medium, which is simulated by a computing device, such as mobile phone, tablet computer, etc. or picked from a database of visual data according to certain criteria or parameter as mentioned above.

Said pictures of the patterns are summed up by layering them by means of the information processing device (1). For example, a sentence or a greeting is pronounced by a user. Said sentence or greeting is split into phonetic elements or groups, i.e. words of syllables. Each of said elements or groups create different vibrational patterns which are simulated by a said computing device or picked from a database of visual data. Captured pictures are layered by means of the information processing device (1) and printed or stored in USB, CD or similar type data storage unit, or sent to the user, employing data communication networks. This method is called parallelization of images.

Yet in another preferred embodiment, variable acoustic information is separated into number of phonetic elements, such as words or syllables. Said phonetic elements are parallelized in the information processing device (1) and emitted at once. In this embodiment usually one image is captured, which represents vibrations, induced by all phonetic elements in the liquid or friable medium. This method is called parallelization of phonetic elements.

1. A method of visualizing acoustic information, the method comprising:
receiving said acoustic information, and
at least one of analyzing, modelling, and rendering the acoustic information into visual data,
wherein the visual data represents a vibrational pattern of surface of at least one of a liquid and a friable medium affected by said acoustic information, transferred by means of acoustic waves.

2. The method according to claim 1, wherein the visual data is picked from a database by finding data that corresponds most closely to a characteristic of said acoustic information.

3. The method according to claim 1, wherein the visual data is generated by simulating the vibrational pattern of the surface of the at least one of the liquid and the friable medium, affected by said acoustic waves.

4. The method according to claim 1, wherein the visual information is rendered from elements of the visual information, by keeping at least one of rotational symmetry and reflection symmetry, and wherein said elements essentially represent characteristic elements of the vibrational pattern.

5. The method according to claim 1, wherein the method further comprises at least one of (a) displaying said visual data on a display, (b) saving said visual data on a data storage medium, (c) printing said visual data, and (d) sharing said visual data.

6. The method according claim 1, wherein the visual data is processed according to multiple conditional options determined by a user.

7. The method according to claim 1, wherein the acoustic information comprises at least one of a sound made by speech, a piece of music, a recording, a live play, and a sound from nature.

8. The method according to claim 1, further comprising:
splitting the acoustic information into phonetic elements,
at least one of picking and modeling characteristic visual information for each of the phonetic elements separately, and
layering the visual information to create a single visual output file.

9. The method according to claim 1, further comprising:
splitting the acoustic information into phonetic elements, and
at least one of picking and modeling visual data for the phonetic elements to be played-back simultaneously.

10. A system for visualizing acoustic information, comprising:
a sound receiving device, and
information processing means configured to analyze said acoustic information and to at least one of pick and generate a corresponding image or images, whereas said image or images represent a vibrational pattern of a surface of at least one of a liquid and a friable medium, affected by said acoustic information.

11. The system according to claim 10, wherein the system is configured to carry out a method comprising:
receiving said acoustic information, and
at least one of analyzing, modelling, and rendering the acoustic information into visual data,
wherein the visual data represents the vibrational pattern of the surface of the at least one of the liquid and the friable medium affected by said acoustic information, transferred by means of acoustic waves.

12. The system according to claim 10, wherein the sound receiving device and the information processing means of the system are comprised within a user terminal.

13. The system according to claim 12, wherein the system further includes a remote server, which stores a database of visual data and wherein the user terminal is arranged to communicate with the server in order to pick appropriate visual data from said database.

14. The method according to claim 1, wherein the vibrational pattern is provided as an artistic expression

15. The method according to claim 6, wherein the multiple conditional options are selected from: (a) a type or property of illumination, (b) a shape of a container that contains the at least one of the liquid and the friable medium, and (c) a type or property of the at least one of the liquid and the friable medium.

16. The method according to claim 3, wherein the visual information is rendered from elements of the visual information, by keeping at least one of rotational symmetry and reflection symmetry, and wherein said elements essentially represent characteristic elements of the vibrational pattern.

17. The method according to claim 4, wherein the method further comprises at least one of (a) displaying said visual data on a display, (b) saving said visual data on a data storage medium, (c) printing said visual data, and (d) sharing said visual data.

18. The method according to claim 7, further comprising:
splitting the acoustic information into phonetic elements,
at least one of picking and modeling characteristic visual information for each of the phonetic elements separately, and
layering the visual information to create a single visual output file.

19. The method according to claim 8, further comprising:
splitting the acoustic information into phonetic elements, and
at least one of picking and modeling visual data for phonetic elements to be played-back simultaneously.

20. The system of claim 12, wherein the user terminal comprises at least one of a smart phone, a tablet computer, and a smart TV.
